(19) United States
(12) Patent Application Publication
(10) Pub. No.: US 2020/0002989 A1
(43) Pub. Date: Jan. 2, 2020

(54) PIVOTABLE CORNER ELEMENT FOR A RADIATION PROTECTION WALL AND RADIATION PROTECTION WALL

(71) Applicant: LASERVISION GmbH & Co. KG, Furth (DE)

(72) Inventors: Klaus BESCHERER-NACHTMANN, Nürnberg (DE); Thomas FRÖHLICH, Lauf an der Pegnitz (DE)

(21) Appl. No.: 16/460,157

(22) Filed: Jul. 2, 2019

(30) Foreign Application Priority Data
Jul. 2, 2018 (DE) 10 2018 210 869.2

(51) Int. Cl. E05D 11/00; E05D 3/02; E05D 9/00

(52) U.S. Cl. CPC E05D 11/0054; E05D 2011/0072; E05D 9/005; E05D 3/02

(57) ABSTRACT

A pivotable corner element for a radiation protection wall comprises at least one hinge defining a pivot axis and two side elements connected via the at least one hinge, wherein the side elements can be pivoted relative to one another around the pivot axis. Upon pivoting of the side elements, an intermediate space between the side elements results depending on a respective pivot position. The corner element has at least one blind arranged in the intermediate space, wherein the at least one blind is displaceable relative to the side elements in a way that the at least one blind at least partially covers the intermediate space independently from the respective pivot position.

### CROSS-REFERENCES TO RELATED APPLICATIONS

This application claims the priority of German Patent Application, Serial No. DE 10 2018 210 869.2, filed on Jul. 2, 2018, pursuant to 35 U.S.C. 119(a)-(d), the content of which is incorporated herein by reference in its entirety as if fully set forth herein.

### FIELD OF THE INVENTION

The invention relates to a pivotable corner element for a radiation protection wall, in particular a laser protection wall. The invention further relates to a radiation protection wall, in particular a laser protection wall, comprising such a pivotable corner element.

### BACKGROUND OF THE INVENTION

Radiation protection walls are used to shield from radiation, such as X-radiation or laser radiation. Radiation protection walls may have pivotable corner elements in order to adapt to respective application sites or application purposes.

Pivotable corner elements are known, for example, from DE 363 235 A and GB 2 560 397 A. WO 2012/000 590 A1 discloses a radiation protection curtain.

### SUMMARY OF THE INVENTION

It is an object of the present invention to provide an improved pivotable corner element for a radiation protection wall, in particular to create a corner element which, independently from its pivot position, is opaque to radiation.

This object is achieved according to the invention by a pivotable corner element for a radiation protection wall, in particular laser protection wall, comprising at least one hinge defining a pivot axis, two side elements connected via the at least one hinge, which can be pivoted relative to one another around the pivot axis, thus forming an intermediate space between the side elements depending on a respective pivot position of the side elements, and at least one blind arranged in the intermediate space between the side elements,

wherein the at least one blind is displaceable relative to the side elements in order to at least partially cover the intermediate space, resulting from and depending on the pivot position of the side elements, in each pivot position of the side elements.

The intermediate space resulting from and varying due to pivoting of the side elements may create radiolucent openings, in particular gaps in the area of the pivot axis, between the side elements. The position of the displaceable at least one blind can be adapted to the respective pivot position. The at least one blind reliably covers the intermediate space resulting between the side elements. Preferably, the at least one blind entirely covers the intermediate space independently from the respective pivot position of the side elements. By this means, radiolucent openings are reliably shielded. Exiting radiation is reduced, in particular entirely avoided, thus increasing radiation safety.

The at least one blind is a component of the corner element. Shielding of radiation is therefore ensured independently from further covers that may be applied subsequently, such as covering materials. The installation of the radiation protection wall is simplified. Furthermore, undesired detaching or shifting of subsequently applied covers, which may lead to exiting radiation, is avoided by means of the at least one blind integrated into the corner element. The radiation protection effect is reliable and secure.

The surfaces of the corner elements facing the radiation source during intended operation will be named as inner surfaces in the following. These inner surfaces can run in parallel to further wall surfaces facing the radiation source. The at least one hinge, preferably, is arranged on the side facing the radiation source, i.e. on the side of the inner surfaces of the corner element.

The pivot position of the side elements relative to one another can be quantified by the opening angle b. The opening angle b is defined as the angle formed between the two inner surfaces of the side elements. Opening angle b=180° defines an even position of the side elements. In the even position of the side elements, their inner surfaces lie in one common plane. Pivoting of the side elements relative to one another may take place out of the even position into a pivot position for which b<180° applies. Depending on the construction of the hinge and/or the displaceable blind, pivoting may take place up to a minimum opening angle. The minimum opening angle is for example 135°, in particular 90°, in particular 45°, preferably 0°. A small minimum angle is advantageous, in particular with regard to space-saving stowage and transport of the radiation protection wall. An opening angle b=0° means that the inner surfaces of the side elements lie on top of each other. In this case, the side elements are entirely folded down.

In the even position, the intermediate space between the two side elements may be closed. The intermediate space may open up for b<180° . In particular, the intermediate space may increase along with decreasing opening angle b.

The at least one blind that is displaceable relative to the side elements has the advantage that shielding of radiation is ensured independently from the pivot position of the side elements even for small opening angles b, in particular opening angles b<90°. Displacement of the at least one blind preferably takes place depending on the opening angle b. In particular, preferably the at least one blind may be pivoted around the pivot axis relative to the side elements. A blind that can be pivoted around the pivot axis may be optimally adapted to the respective pivot position of the side elements. The protective effect of the radiation protection wall is hereby further increased.

According to one advantageous aspect of the invention, the at least one blind is connected, in particular rigidly connected, with the at least one hinge. This allows for easy pivoting of the at least one blind around the pivot axis. In particular, the at least one blind can be pivoted around the pivot axis in a guided manner In addition, a direct connection between the at least one blind and the side elements is not necessary. This ensures smooth and reliable pivoting of the at least one blind relative to the side elements.

According to one further preferred aspect of the invention, there are at least two blinds that can be pivoted relative to one another around the pivot axis. Preferably, the at least two blinds may be slid fan-like on top of each other. For large opening angles b the blinds may overlap, in particular entirely overlap, in pivot direction. For small opening angles b the blinds may be fanned out. Thus, even with small opening angles b, the intermediate space between the side elements is reliably shielded. Providing several blinds ensures compact and especially radiation-proof design of the corner element. Preferably, three blinds are provided.

According to one further advantageous aspect of the invention, the at least one blind has a blind blade shaped as a circular arc around the pivot axis. A blind blade shaped as a circular arc around the pivot axis is adapted to the pivoting movement around the pivot axis. An intermediate space resulting from pivoting of the side elements may be optimally covered by the circular arc-shaped blind blade of the at least one blind. Besides the blind blade shaped as a circular arc, the at least one blind may have further components, such as rear walls. However, the at least one blind may also essentially consist only of the blind blade. In this case, the at least one blind as a whole may be shaped as a circular arc around the pivot axis.

Preferably, at least two blinds are provided with one blind blade shaped as a circular arc around the pivot axis, respectively. Upon pivoting, the circular arc-shaped blind blades of the at least two blinds may be slid on top of one another smoothly and in space-saving manner

According to one further advantageous aspect of the invention, the side elements have blind receptacles adapted to the circular arc shape of the blind blade of the at least one blind. In particular with large opening angles, for example in the even position, the at least one blind, in particular its blind blade, may at least partially rest within the blind receptacle. The blind receptacle allows for compact design of the corner element. Furthermore, at least the portion of the at least one blind resting within the blind receptacle is protected from environmental impacts. It is also advantageous that the at least one blind may be guided within the receptacles adapted to the circular arc shape. This ensures particularly stable and reliable pivoting.

According to one further advantageous aspect of the invention, the corner element has three blinds, specifically two side blinds and one center blind.

The side blinds, respectively, have one side blind blade shaped along a common side circular arc around the pivot axis. The center blind has one center blind blade shaped along a center circular arc around the pivot axis. The radii of the center circular arc and the side circular arc are different. Thus, the side blind blades and the center blind blade may be pivoted concentrically relative to each other and slid on top of one another. The side blinds may be arranged adjacent to one of the side elements, respectively. The center blind may be arranged between the two side blinds. Preferably, the radius of the side circular arc is larger than the radius of the center circular arc. The side blind blades may therefore be slid on top of the center blind blade. Particularly preferably, the radius of the side circular arc essentially exceeds the radius of the center circular arc by the thickness of the blind blades. By this means, the side blind blades have a small radial distance towards the center blind blade. Exiting radiation between the blind blades is reliably avoided.

According to one further advantageous aspect of the invention, the corner element has one catch device per blind. Each catch device is configured to carry along the respective blind upon pivoting of the side elements, if the opening angle b of the side elements is smaller than a catch angle predefined for the respective blind. In case of a plurality of blinds, preferably, a different catch angle is predefined for each blind, respectively. The catch angle is defined like the opening angle b. As long as the opening angle b is larger than the catch angle of the respective blind, the blind will be decoupled from the pivoting movement of the side elements. As soon as the opening angle b drops below the respective catch angle, the blind will be coupled to the pivoting movement of the side elements by means of the catch device. Carrying along the respective blind is thus carried out by displacing, in particular pivoting, the blind corresponding to the pivoting movement of the side elements. Preferably, carrying along is carried out by pivoting the blind synchronously with the side elements.

Carrying along the at least one blind, preferably, is carried out only with decreasing opening angle b. The catch device, however, may also be configured in a way that carrying along the blind is also carried out with increasing opening angle b, provided that the opening angle b is not larger than the respective catch angle.

According to one further preferred aspect of the invention, each catch device is configured by means of stops within the at least one hinge. Such a design of the catch device of the at least one blind is simple, robust and space-saving. For example, two blind couplings per hinge may be provided. In the blind couplings, the stops for each catch device may be arranged in different functional levels. The catch angle may be defined in a simple and precise manner by means of a spacing between the stops in pivot direction.

According to one further preferred aspect of the invention, the side elements have one mounting block, respectively, in the area of the at least one hinge. The mounting blocks of the side elements may be solid. In addition, the side elements may have facing frames. The facing frames may form a hollow profile in which the mounting blocks are accommodated. The mounting blocks ensure a stable design of the corner element, in particular in the area of the at least one hinge. At the same time, the side elements may have low weight due to the facing frames configured as a hollow profile.

According to one further preferred aspect of the invention, the at least one mounting block per side element has cut sheets of metal stacked on top of one another in the direction of the pivot axis. The cut sheets of metal stacked on top of one another allow for high flexibility regarding the design of the mounting blocks. The mounting blocks may, for example, be manufactured by means of the LOM (Laminated Object Modelling) method.

The at least one hinge may be formed by the cut sheets of metal of the mounting blocks. For example, the cut sheets of metal may engage with one another alternatingly. A hinge of that kind is stable and failsafe. In addition, individual cut sheets of metal of the mounting block may serve as functional levels of the blind coupling. These cut sheets of metal may, for example, be configured as stopper plates for the catch device.

According to one further advantageous aspect of the invention, the side elements have fastening elements for fastening additional components of the radiation protection wall, in particular for fastening wall elements. Preferably, the fastening elements are anchored in the mounting blocks of the side elements. The fastening elements, in particular, allow for a detachable connection of additional components of the radiation protection wall with the corner element. This provides for a modular setup of the radiation protection wall. The components of the radiation protection wall may be combined according to the respective requirements.

According to one further advantageous aspect of the invention, the at least one blind comprises a radiation protection material. Preferably, the at least one blind is entirely made of radiation protection material. Particularly preferably, further parts of the corner element are made of radiation protection material, as well. The radiation protection material may, in particular, absorb the respective radiation. By this means, a peculiarly high protective effect of the radiation protection wall is ensured.

The radiation protection wall may, in particular, be a laser protection wall.

In this case, the at least one blind, and preferably also further components of the corner element, comprise a laser protection material. Suitable laser protection materials are in particular metals, preferably aluminium or steel. Alternatively, graphite, metal-graphite-composites, metal-plastic-composites and/or suitable plastic materials may be used as laser protection materials. The use of laser protection glass is possible, as well.

It is one further object of the invention to improve a radiation protection wall, in particular to provide a radiation protection wall that is flexible in use and radiopaque.

This object is achieved by a radiation protection wall comprising the features named in claim 13. The radiation protection wall has at least two wall elements that are connected by a pivotable corner element, as it is described above. The two wall elements may be pivoted relative to one another via the pivotable corner element. The radiation protection wall is flexible and radiopaque, independently from a pivot position of the corner element. Further advantages of the radiation protection wall arise out of the advantages of the pivotable corner element.

Advantageously, the radiation protection wall is based on a modular design. For example, further wall elements and/or corner elements may be connected with the radiation protection wall. The radiation protection wall is extendable and may easily be adapted to the respective individual application. In addition, the wall elements may be detachably connected with the corner profile, with the result that the wall elements may be exchanged. The wall elements themselves may consist of wall plates inserted in frame profiles. For example, according to the respective radiation source to be shielded, wall plates of different radiation protection materials may be used.

Preferred embodiments of the invention will be described below by way of example with reference to the accompanying drawings.

### BRIEF DESCRIPTION OF THE DRAWINGS

FIG. 1 shows a perspective view of a first embodiment of a laser protection wall comprising two wall elements connected via one corner element,

FIG. 2 shows a section through the laser protection wall according to

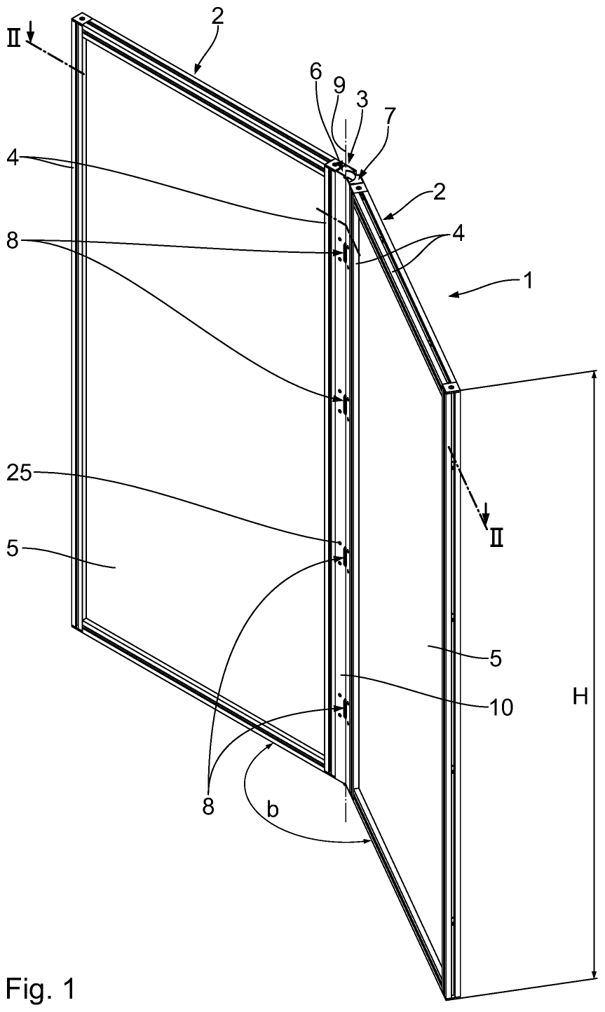

FIG. 1 along the cutting edge II-II in an even position, wherein wall plates of the wall elements are not shown for the sake of clarity,

FIG. 3 shows a side view of two mounting blocks and of blinds of the corner element of the laser protection wall according to FIG. 1 in even position,

FIG. 4 shows a detail IV of the side view according to FIG. 3,

FIG. 5 shows a top view onto the mounting blocks and blinds according to FIG. 3 in an even position, wherein anchor plates of the mounting blocks are not shown for the sake of better clarity,

FIG. 6 shows a top view onto the mounting blocks and blinds according to FIG. 5 in a pivot position that corresponds to an opening angle of 130°,

FIG. 7 shows a top view onto the mounting blocks and blinds according to FIG. 5 in a pivot position that corresponds to an opening angle of 90°, wherein one block stopper plate of one of the mounting blocks is not shown for the sake of clarity,

FIG. 8 shows a top view onto the mounting blocks and blinds according to FIG. 7 in a pivot position that corresponds to an opening angle of 50°,

FIG. 9 shows a top view onto the mounting blocks and blinds according to FIG. 7 in a pivot position that corresponds to an opening angle of 0°,

FIG. 10 shows a perspective view of a second embodiment of a laser protection wall in a pivot position that corresponds to an opening angle of 150°, and

FIG. 11 shows a perspective view of the laser protection wall according to FIG. 10 in a pivot position that corresponds to an opening angle of 30°.

### DESCRIPTION OF THE PREFERRED EMBODIMENTS

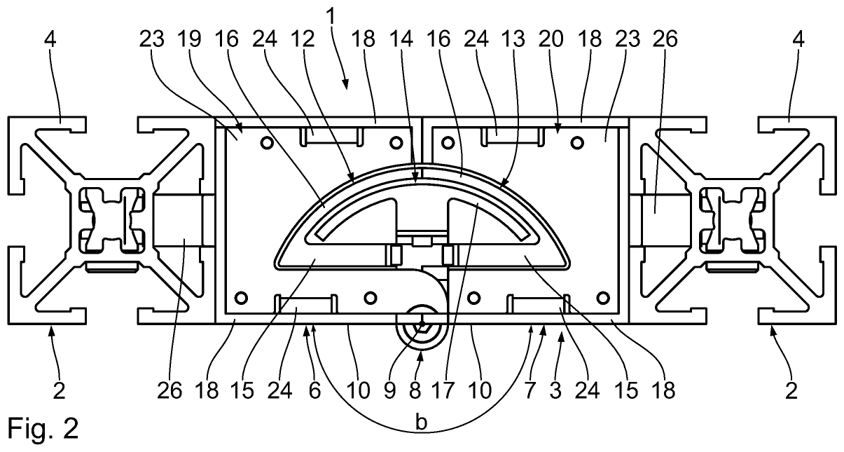

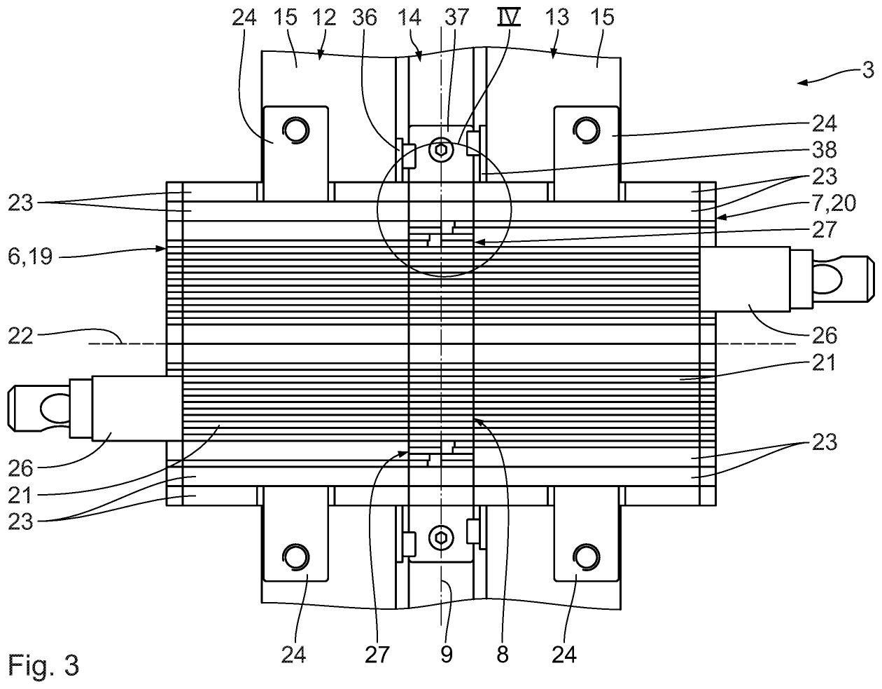

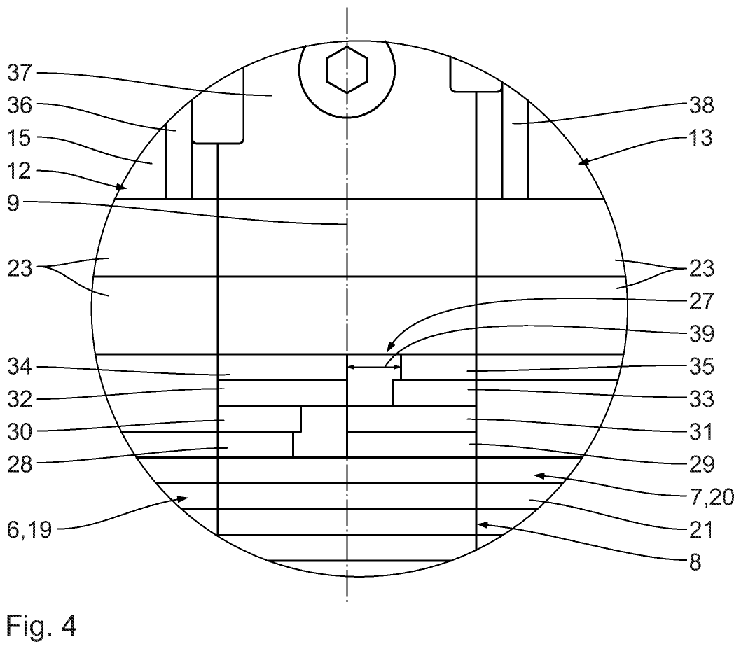

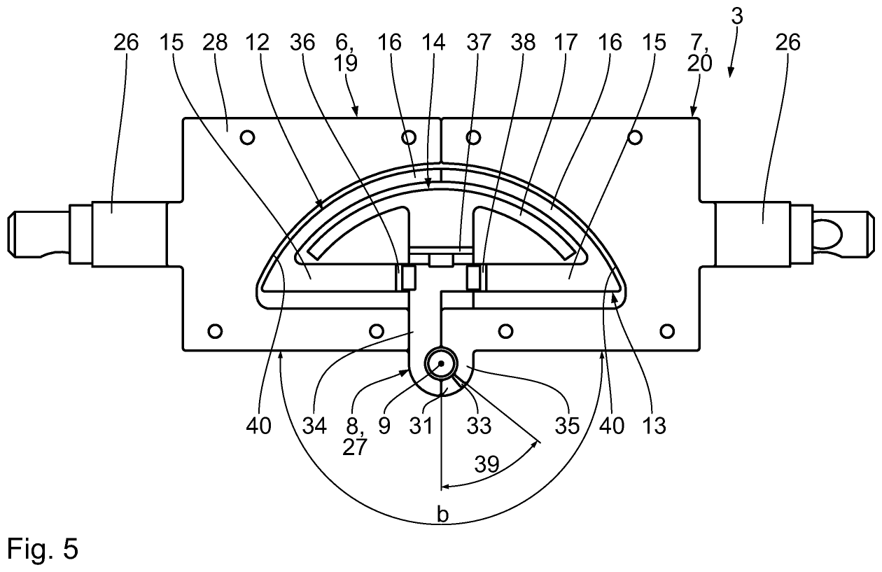

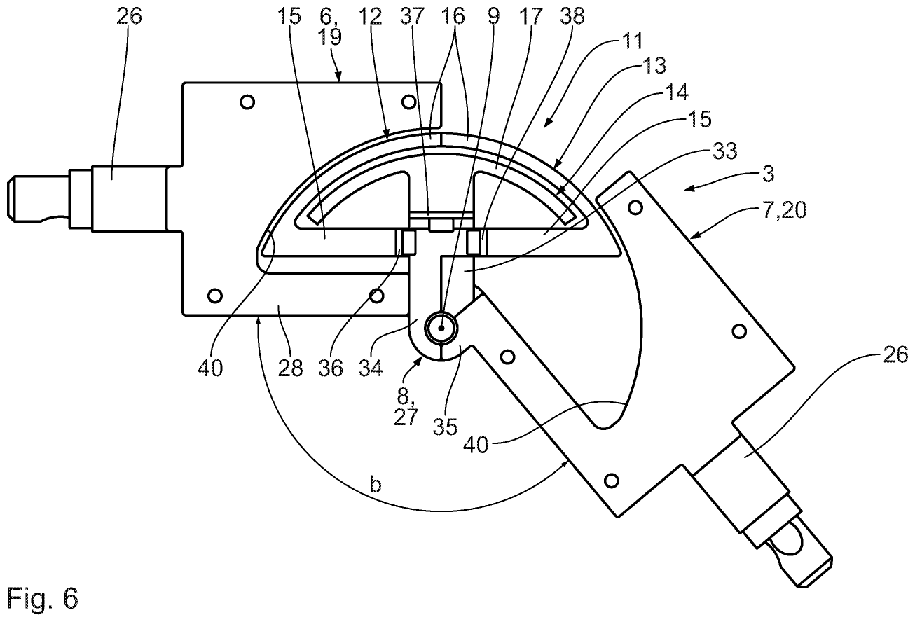

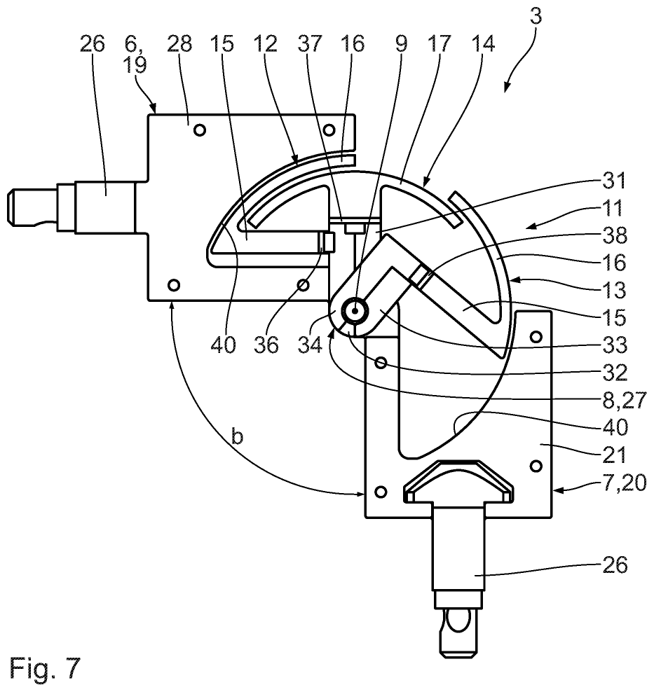

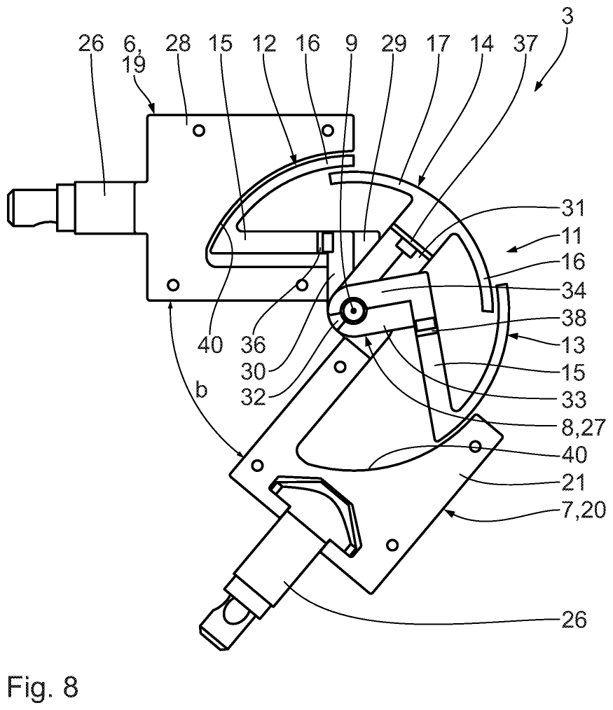

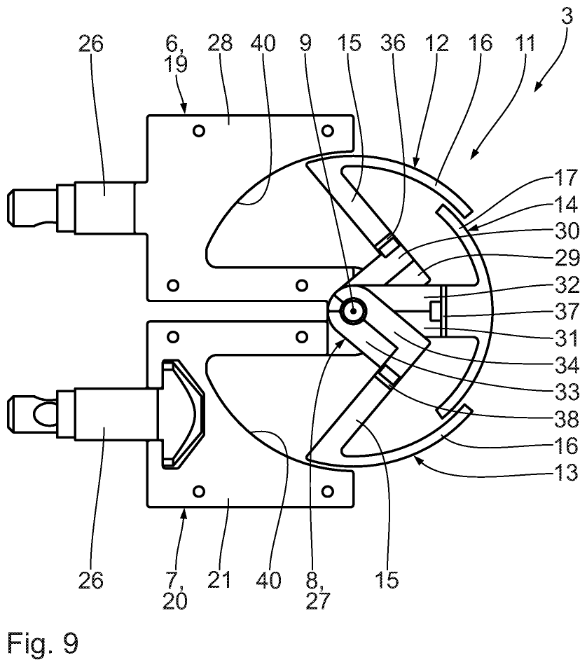

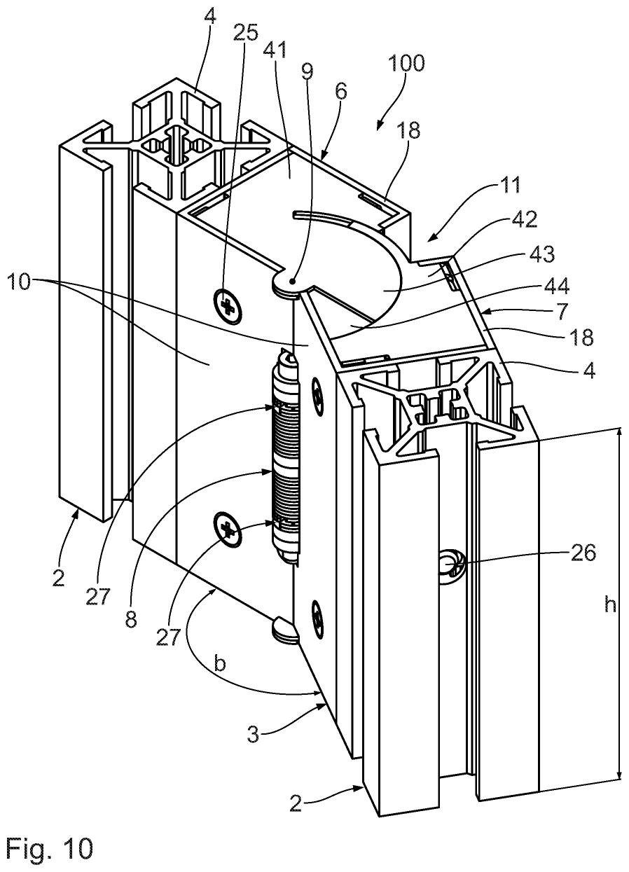

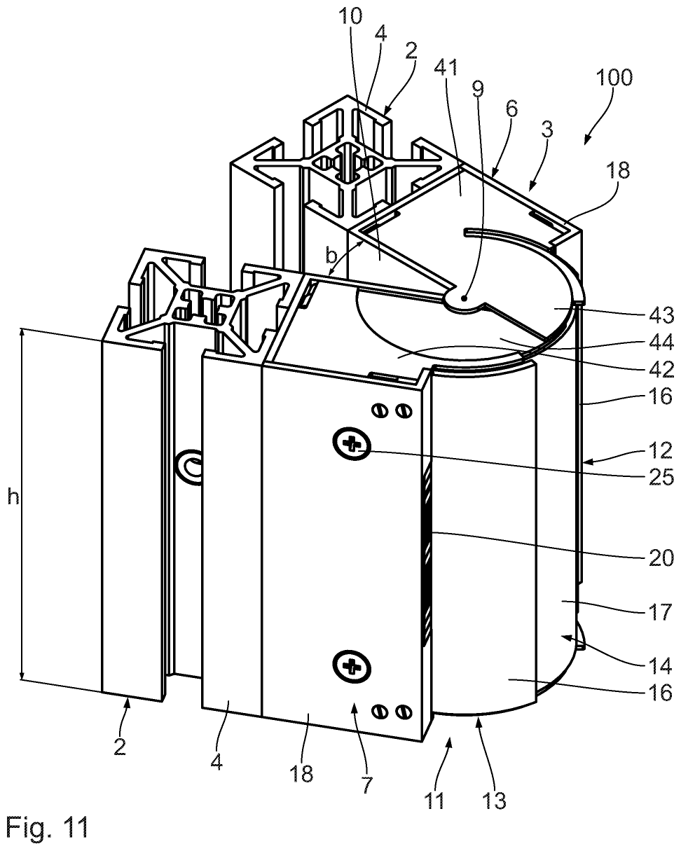

Referring to FIGS. 1 to 9, a first embodiment of a radiation protection wall 1 is described. The radiation protection wall 1 is a laser protection wall. The laser protection wall 1 has two wall elements 2 and a corner element 3 connecting the wall elements 2. The wall elements 2 have frame profiles 4 and wall plates 5 fixed therein. The frame profiles 4 are arranged circumferentially around the wall plates 5 and serve as connection between the wall elements 2 and the corner element 3 or further wall elements. Via the frame profiles 4, the laser protection wall 1 can be extended by and combined with further elements. The laser protection wall 1 has a modular setup. For the sake of clarity, only the frame elements 4 adjacent to the corner elements 3, but no further components of the wall elements 2, in particular no wall plates 5 are shown in FIG. 2.

The corner element 3 comprises a first side element 6 and a second side element 7. The first side element 6 is connected with the second side element 7 via several hinges 8. The hinges 8 define a common pivot axis 9. The laser protection wall 1 has a height H in the direction of the pivot axis 9. The hinges 8 are evenly distributed along the pivot axis 9, across the height H. The side elements 6, 7 and the wall elements 2 connected therewith, respectively, can be pivoted relative to one another around the pivot axis 9. The corner element 3 is also named as pivotable corner element 3.

The laser protection wall 1 serves for shielding from laser radiation of a laser radiation source that is not shown in the drawings. The laser radiation source is arranged to the side of the laser protection wall 1 where the hinges 8 are located. The surfaces of the corner element 3 that are facing the laser radiation source are named as inner surfaces 10 (cf. FIG. 2) of the side elements 6, 7. The inner surfaces 10 of the side elements 6, 7 are parallel to the surfaces of the wall plates 5 facing the laser radiation source.

A respective pivot position of the side elements 6, 7 relative to one another is quantified by an opening angle b. The opening angle b is defined as the angle formed between the inner surfaces 10 of the side elements 6, 7. In FIG. 2, the side elements 6, 7 of the corner element 3 and therefore also the wall elements 2 are shown in an even position. In the even position, the opening angle b=180°. In the even position, the inner surfaces 10 of the side elements 6, 7 lie in one plane. For the pivot positions differing from the even position, b<180° applies. In FIG. 1, for example, a pivot position is shown whose respective opening angle b=130°.

Upon pivoting of the side elements 6, 7 relative to one another, an intermediate space 11 results between the side elements 6, 7 depending on the respective pivot position. In the even position, the intermediate space 11 is closed. Accordingly, in the figures showing the even position (cf. in particular FIGS. 2 and 5), the intermediate space 11 is not drawn. For b <180, the intermediate space 11 between the side elements 6, 7 opens up (see FIGS. 6 to 9). In order to avoid that laser radiation may exit via the intermediate space 11, a first side blind 12, a second side blind 13 and a center blind 14 are arranged in the intermediate space 11. The blinds 12, 13, 14 extend across the entire height H of the laser protection wall. They may be pivoted relative to one another and relative to the side elements 6, 7 around the pivot axis 9 in a way that the intermediate space 11 is entirely covered by the blinds 12, 13, 14 independently from the pivot position of the side elements 6, 7. The blinds 12, 13, 14 are shielding reliably from laser radiation independently from the pivot position of the side elements 6, 7.

The side blinds 12, 13 have rear walls 15, respectively, and side blind blades 16 connected therewith. The side blind blades 16 are shaped as a circular arc along a side circular arc around the pivot axis 9. The center blind 14, as well, has a center blind blade 17 extending circular arc-shaped along a center circular arc around the pivot axis 9. The circular arcs described by the side blind blades 16 and the center blind blade 17 are concentric. The center circular arc has a reduced radius compared to the side circular arc. The difference between the radii essentially corresponds to one thickness of the blind blades 16, 17 in radial direction. By means of the circular arc shape of the blind blades 16, 17 and the different radii, the blind blades 16, 17 of the blinds 12, 13, 14 may be slid on top of one another. In particular, the center blind 14 may be accommodated in a free space formed by the side blind blades 16 and the rear walls 15.

In the following, the setup of the side elements 6, 7 as well as their interacting with the blinds 12, 13, 14 upon pivoting will be described. The side elements 6, 7, respectively, have facing frames 18 extending across the entire height H of the laser protection wall 1. In the area of the hinges 8, the first side element 6 has one first mounting block 19, respectively, and the second side element 7 has one second mounting block 20, respectively.

FIG. 3 shows a side view of one of the mounting blocks 19 of the first side element 6 and of one of the mounting blocks 20 of the second side element 7 as well as of the blinds 12, 13, 14 in even position. The mounting blocks 19, 20 have a layer structure of several cut metal sheets 21 stacked on top of one another in the direction of the pivot axis 9. A layer structure of that kind may, for example, be manufactured by means of the so-called LOM method (Laminated Object Modelling). The layer structure of the second mounting block 20 is implemented mirror-symmetrically to the layer structure of the first mounting block 19, relative to a center plane 22 extending vertically to the pivot axis 9. The hinges 8 are formed by the cut metal sheets 21 of the respective mounting blocks 19, 20. For this purpose, the cut metal sheets 21 of the first mounting block 19 at least section-wise overlap alternatingly with the cut metal sheets 21 of the second mounting block 20 in the area of the respective hinge 8. The mounting blocks 19, 20 have anchor plates 23 with anchor lugs 24 located at the edge in the direction of the pivot axis 9, respectively. The anchor lugs 24 have screwing bores via which the mounting blocks 19, 20 may be screwed to the facing frames 18 by means of anchor bolts 25 (cf. FIG. 1). Each mounting block 19, 20 has one fastening element 26, respectively. The fastening elements 26 jut out beyond the mounting blocks 19, 20 and the facing frames 18 in the direction of the respective wall elements 2. The fastening elements 26 serve for fixing the frame profiles 4 of the wall elements 2 to the corner elements 3.

The blinds 12, 13, 14 are connected with the hinges 8 via blind couplings 27, respectively. According to the symmetry of the mounting blocks 19, 20, two blind couplings 27 are provided per hinge 8. The blind couplings 27 are components of the hinges 8. The blind couplings 27 are arranged between the anchor plates 23 and further cut metal sheets 21 of the mounting blocks 19, 20. In FIG. 4, a side view of the blind coupling 27 is shown in detail. The blind coupling 27 has four functional levels lying on top of each other in the direction of the pivot axis 9. In each functional level, relative to the pivot direction, two stopper plates are situated opposite to each other. In a first functional level, a first block stopper plate 28 is provided. Opposite to the first block stopper plate 28, a first side stopper plate 29 is arranged. In the second functional level, a second side stopper plate 30 and a first center stopper plate 31 are situated opposite to each other. In the third functional level, a second center stopper plate 32 and a third side stopper plate 33 are situated opposite to each other. In the fourth functional level, a fourth side stopper plate 34 and a second block stopper plate 35 are situated opposite to each other. The first block stopper plate 28 is a cut metal sheet of the first mounting block 19. The second block stopper plate 35 is a cut metal sheet of the second mounting block 20. The first side stopper plate 29 and the second side stopper plate 30 are rigidly connected with the rear wall 15 of the first side blind 12 via a first side anchor 36 by means of a screw connection. The center stopper plates 31, 32 are rigidly connected with the center blind 14 via a center anchor 37. Likewise, the third side stopper plate 33 and the fourth side stopper plate 34 are rigidly screwed to the rear wall 15 of the second side blind 13 via a second side anchor 38.

The stopper plates opposing each other form stops that cause a coupling of the pivoting movements of the components that are rigidly connected with the stopper plates. For example, when the first block stopper plate 28 strikes the first side stopper plate 29 in the first functional level, the first mounting block 19 is coupled to the first side blind 12. Therefore, by means of the stops configured in the different functional levels, a catch device is created, respectively, which may carry along the respective blinds 12, 13, 14 upon pivoting of the side elements 6, 7 relative to one another.

In the even position shown in FIG. 4, there is a pivot spacing, respectively, between the stopper plates opposing each other in the individual functional levels. In FIG. 4, an exemplary pivot spacing 39 between the fourth side stopper plate 34 and the second block stopper plate 35 is shown. The pivot spacings define a freewheel allowing for pivoting of one stopper plate relative to the opposing stopper plate in the respective functional level before these two strike against each other and result in a coupling of the pivoting movements. The pivot spacings thus define a catch angle that is different for the respective blinds 12, 13, 14 and from which the movement of the opposing stopper plates starts to couple.

The functional principle of the blind coupling 27 and the pivoting blinds 12, 13, 14 will be explained in the following referring to FIGS. 5 to 9. These figures, respectively, show a top view onto the mounting blocks 19, 20 and the blinds 12, 13, 14 in different pivot positions. In the figures, the anchor plates 23 with the anchor lugs 24 are not shown, with the result that details of the blind coupling 27 become visible.

In FIG. 5, the mounting blocks 19, 20 and the blinds 12, 13, 14 are shown in even position. The opening angle b is 180°. The top view shows the first block stopper plate 28 of the first mounting block 19 and the second block stopper plate 35 of the second mounting block 20. In the blind coupling 27, the fourth side stopper plate 34, which is rigidly connected with the second side blind 13 via the second side anchor 38, is situated opposite to the second block stopper plate 35. Between the fourth side stopper plate 34 and the second block stopper plate 35 the pivot spacing 39 is marked. In the area of the pivot spacing 39, a part of the third side stopper plate 33 and the center stopper plate 31 of the subjacent functional levels can be seen.

In the even position shown in FIG. 5, the blind blades 16, 17 are maximally slid on top of one another. In particular, the center blind 14 lies within the free space between the side blind blades 16 and the rear walls 15 of the side blinds 12, 13. In the even position, the intermediate space 11 between the side elements 6, 7 is closed. The blinds 12, 13, 14 entirely rest within blind receptacles 40 of the side elements 6, 7. The blind receptacles 40 have a contour that is adapted to the circular arc shape of the side blind blades 16. They are configured within the mounting blocks 19, 20.

In FIG. 6, a top view onto the mounting blocks 19, 20 and the blinds 12, 13, 14 is shown. The second mounting block 20 is pivoted relative to the first mounting block 19 and the blinds 12, 13, 14. The pivot position shown corresponds to an openings angle b=130°. Between the side elements 6, 7 and between their mounting blocks 19, 20, respectively, the intermediate space 11 has opened up. In the pivot position shown, the second block stopper plate 35 of the second mounting block 20 strikes the fourth side stopper plate 34. As a result, the second side blind 13 that is rigidly connected with the fourth side stopper plate 34 is coupled to the second mounting block 20. The opening angle b=130° corresponds to a catch angle for the second side blind 13. If the opening angle b is further reduced, the second side blind 13 is pivoted likewise. With an increasing opening angle b, however, the coupling is disengaged.

FIG. 7 shows a top view onto the mounting blocks 19, 20 and the blinds 12, 13, 14 in a pivot position corresponding to an opening angle b of 90°. In the pivot position shown, the second mounting block 20 is pivoted even further relative to the first mounting block 19. The intermediate space 11 is further increased. Since b=90° is smaller than the catch angle of the second side blind 13, the second side blind 13, as well, is pivoted relative to the first mounting block 19 and the further blinds 12, 14. Due to the pivoted second side blind 13, the intermediate space 11 continues to be entirely covered by the blinds 12, 13, 14.

In FIGS. 7 to 9, the second block stopper plate 35 of the second mounting block 20 is not shown. As a result, further details of the blind coupling 27 can be seen. For the opening angle b=90°, the third side stopper plate 33 strikes the second center stopper plate 32. The opening angle b=90° thus corresponds to a catch angle for the center blind that is rigidly connected with the second center stopper plate 32. If the second mounting block 20 is pivoted further relative to the first mounting block 19, i.e. if the opening angle b is further reduced, the center blind 14, as well, together with the second side blind 13 and the second mounting block 20, will be pivoted relative to the first mounting block 19 and the first side blind 12.

As a result of the fact that the second block stopper plate 35 is not shown in FIG. 7, a subjacent cut sheet of metal 21 of the second mounting block 20, where the fastening element 26 is anchored, is visible.

In FIG. 8, a top view onto the mounting blocks 19, 20 and the blinds 12, 13, 14 in a pivot position corresponding to an opening angle b=50° is shown. In the pivot position shown, the mounting block 20 is pivoted even further relative to the mounting block 19, the intermediate space 11 is further increased. Since the opening angle b=50° is smaller than the catch angle for the second side blind 13 and the center blind 14, the second side blind 13 as well as the center blind 14 are pivoted relative to the first mounting block 19 and the first side blind 12. By this means, the intermediate space 11 continues to be entirely covered by the blinds 12, 13, 14.

The pivoted center blind 14 reveals the first side stopper plate 29 and the second side stopper plate 30, which are rigidly connected with the first side blind 12 via the first side anchor 36. The opening angle b=50° corresponds to the catch angle for the first side blind 12. If the second mounting block 20 is pivoted further relative to the first mounting block 19, i.e. if the opening angle b is further reduced, the first side blind 12, as well, together with the further blinds 13, 14 and the second mounting block 20, will be pivoted relative to the first mounting block 19.

In FIG. 9, a top view onto the mounting blocks 19, 20 and the blinds 12, 13, 14 is shown. The mounting blocks 19, 20 are maximally pivoted relative to one another, with the result that opening angle b=0° applies. If the facing frames 18 of the side elements 6, 7 were shown, their inner surfaces 10 would lie on top of one another. In the pivot position shown, all three blinds 12, 13, 14 are pivoted relative to one another and relative to the mounting blocks 19, 20. The intermediate space 11 continues to be reliably covered.

In the different pivot positions shown in FIGS. 5 to 9, an intermediate space 11 of different size, respectively, results between the side elements 6, 7 or between their mounting blocks 19, 20. With the help of the blind couplings 27, the blinds are pivoted specifically depending on the respective opening angle b, thus entirely covering the intermediate space 11. Laser radiation cannot exit through the corner element 3 independently from the pivot position and the opening angle b.

The wall elements 2 and the corner element 3, in particular the wall plates 5 and the blind blades 16, 17, are made of laser protection material. Exemplary laser protection materials are metals, in particular aluminum or steel, graphite, metal-graphite-composites, metal-plastic-composites and/or glass, preferably laser protection glass. It is also possible to use plastic materials having suitable mechanic solidity and an appropriate radiation protection effect.

In FIGS. 10 and 11, a second embodiment of a laser protection wall 100 is shown. Components that have already been described above referring to FIGS. 1 to 9 have the same reference numbers and will not be discussed in further detail.

The laser protection wall 100 differs from the laser protection wall 1 merely by its low height h in the direction of the pivot axis 9. As a result of its low height h, the corner element 3 of the laser protection wall 100 has only one hinge 8.

For the sake of clarity, the wall plates 5 are not shown in FIGS. 10 and 11. FIG. 10 shows a perspective representation of the laser protection wall 100 for a pivot position corresponding to an opening angle b=150°. In FIG. 11, the laser protection wall 100 is shown for an opening angle b=30°.

The corner element 3 of the laser protection wall 100 has front facing elements 41, 42 attached to the front sides. The corner element 3 of the laser protection wall 1 has corresponding front facing elements which, however, have no reference numbers in FIG. 1 for the sake of clarity. The front facing element 41 is allocated to the first side element 6. The second front facing element 42 is allocated to the second side element 7. The front facing elements 41, 42 have cover plates 43, 44 that are shaped as circular segments and may be slid on top of one another. By this means, facing of the front side of the corner element 3 is ensured independently from the pivot position. Laser radiation cannot exit on the front side, either.

In further embodiments that are not shown in the figures, fewer than three or more than three blinds are provided that may be pivoted relative to one another. For example, one single blind whose blind blade covers a large circular arc may be sufficient to allow for pivoting of the side elements over a large opening angle. Assuming that N blinds are provided, the blind couplings of the hinges have N+1 functional levels.

15

What is claimed is:

1. A pivotable corner element for a radiation protection wall, in particular laser protection wall, comprising
at least one hinge defining a pivot axis,
two side elements connected via the at least one hinge, which can be pivoted relative to one another around the pivot axis, thus forming an intermediate space between the side elements depending on a respective pivot position of the side elements, and
at least one blind arranged in the intermediate space between the side elements,
wherein the at least one blind is displaceable relative to the side elements in order to at least partially cover the intermediate space, resulting from and depending on the pivot position of the side elements, in each pivot position of the side elements.

2. The corner element according to claim 1, wherein the at least one blind is connected with the at least one hinge.

3. The corner element according to claim 1, comprising at least two blinds that can be pivoted relative to one another around the pivot axis.

4. The corner element according to claim 1, wherein the at least one blind has a blind blade shaped as a circular arc around the pivot axis.

5. The corner element according to claim 4, wherein the side elements have blind receptacles adapted to the circular arc shape of the blind blade of the at least one blind.

6. The corner element according to claim 1, comprising three blinds, wherein two side blinds of the three blinds, respectively, have one side blind blade configured along a common side circular arc around the pivot axis and one center blind of the three blinds has one center blind blade configured along a center circular arc around the pivot axis, wherein a radius of the center circular arc differs from the radius of the side circular arc.

7. The corner element according to claim 1, comprising at least one catch device per blind, wherein each catch device is configured to carry along the respective blind upon pivoting of the side elements, if an opening angle defined between the side elements is smaller than a catch angle predefined for the respective blind.

8. The corner element according to claim 7, wherein each catch device is configured by means of stops within the at least one hinge.

9. The corner element according to claim 1, wherein the side elements have one mounting block, respectively, in the area of the at least one hinge.

10. The corner element according to claim 9, wherein the at least one mounting block per side element has cut sheets of metal stacked on top of one another in the direction of the pivot axis.

11. The corner element according to claim 1, wherein the side elements have fastening elements for fastening additional components of the radiation protection wall.

12. The corner element according to claim 1, wherein the at least one blind comprises a radiation protection material.

13. The corner element according to claim 12, wherein the at least one blind comprises a laser protection material.

14. A radiation protection wall comprising at least two wall elements being connected via one pivotable corner element according to claim 1.

15. The radiation protection wall according to claim 14, wherein the radiation protection wall is a laser protection wall.

16. The radiation protection wall according to claim 14 comprising a modular setup.
